(19) United States
(12) Patent Application Publication
(10) Pub. No.: US 2023/0271652 A1
(43) Pub. Date: Aug. 31, 2023

(54) CAB WITH ENHANCED VISIBILITY

(71) Applicant: Deere & Company, Moline, IL (US)

(72) Inventor: Troy K. Maddox, LeClaire, IA (US)

(21) Appl. No.: 17/652,576

(22) Filed: Feb. 25, 2022

(51) Int. Cl. B62D 33/06

(52) U.S. Cl. CPC B62D 33/0617

(57) ABSTRACT

A work vehicle that operates on a surface comprising an implement and a cab. The cab comprises a left side portion, a right side portion, a floor coupled to the left side portion forming a left floor edge and coupled to the right side portion forming a right floor edge, and a roof coupled to the left side portion forming a left roof edge and coupled to the right side portion forming a right roof edge. The cab further comprises a frame positioned above the floor in a central portion of the front of the cab. A first support extends from the central portion towards the left floor edge. A second support extends from the central portion towards the right floor edge. A third support extends from the central portion towards the left roof edge. A fourth support extends from the central portion towards the right roof edge.

### FIELD OF THE DISCLOSURE

The present disclosure relates generally to a cab for a work vehicle, and more particularly to a work vehicle comprising a cab with enhanced visibility.

### BACKGROUND OF THE DISCLOSURE

Work vehicles, such as a crawler or motor grader, can be used in construction and maintenance for grading terrain to a flat surface at various angles, slopes, and elevations. When paving a road for instance, a motor grader can be used to prepare a base foundation to create a wide flat surface to support a layer of asphalt. When controlling a ground engaging tool or implement, it is valuable to know when the implement is in contact with a surface. As such, there is a need in the art for a work vehicle having a cab with enhanced or improved visibility so that an operator can see the implement and when the implement is in contact with the surface.

### SUMMARY OF THE DISCLOSURE

According to one embodiment of the present disclosure, a cab for a work vehicle that operates on a surface is disclosed. The cab comprises a longintudinal axis extending between a front of the cab and a rear of the cab opposite to the front of the cab. An operator faces the front of the cab. The cab comprises a left side portion, a right side portion opposite of the left side portion, a floor coupled to the left side portion forming a left floor edge and coupled to the right side portion forming a right floor edge, and a roof coupled to the left side portion forming a left roof edge and coupled to the right side portion forming a right roof edge, the roof positioned above the floor. The cab further comprises a frame supporting the front of the cab. The frame is positioned above the floor in a central portion of the front of the cab. A first support is coupled to the frame and extends from the central portion towards the left floor edge. A second support is coupled to the frame and extends from the central portion towards the right floor edge. A third support is coupled to the frame and extends from the central portion towards the left roof edge. A fourth support is coupled to the frame and extends from the central portion towards the right roof edge.

According to another embodiment of the present disclosure, a work vehicle that operates on a surface is disclosed. The work vehicle comprises an implement and a cab positioned behind the implement. The cab comprises a longintudinal axis that extends between a front of the cab and a rear of the cab opposite to the front of the cab. An operator faces the front of the cab. The cab comprises a left side portion, a right side portion opposite of the left side portion, a floor coupled to the left side portion forming a left floor edge and coupled to the right side portion forming a right floor edge, and a roof coupled to the left side portion forming a left roof edge and coupled to the right side portion forming a right roof edge, the roof positioned above the floor. The cab further comprises a frame supporting the front of the cab. The frame is positioned above the floor in a central portion of the front of the cab. A first support is coupled to the frame and extends from the central portion towards the left floor edge. A second support is coupled to the frame and extends from the central portion towards the right floor edge. A third support is coupled to the frame and extends from the central portion towards the left roof edge. A fourth support is coupled to the frame and extends from the central portion towards the right roof edge.

According to yet another embodiment of the present disclosure a work vehicle that operates on a surface is disclosed. The work vehicle comprises an implement and a cab positioned behind the implement. The cab comprises a longintudinal axis that extends between a front of the cab and a rear of the cab opposite to the front of the cab. An operator faces the front of the cab. The cab comprises a left side portion, a right side portion opposite of the left side portion, a floor coupled to the left side portion forming a left floor edge and coupled to the right side portion forming a right floor edge, and a roof coupled to the left side portion forming a left roof edge and coupled to the right side portion forming a right roof edge, the roof positioned above the floor. The cab further comprises a frame supporting the front of the cab. The frame is positioned above the floor in a central portion of the front of the cab. A first support is coupled to the frame and extends from the central portion towards the left floor edge. A second support is coupled to the frame and extends from the central portion towards the right floor edge. A third support is coupled to the frame and extends from the central portion towards the left roof edge. A fourth support is coupled to the frame and extends from the central portion towards the right roof edge. A seat is coupled to at least one of the left side portion, the right side portion, the floor, and the roof. The seat is positioned to provide the operator a view of the implement below the frame at the front of the cab.

Other features and aspects will become apparent by consideration of the detailed description and accompanying drawings.

### BRIEF DESCRIPTION OF THE DRAWINGS

The detailed description of the drawings refers to the accompanying figures in which:

FIG. 1 is a perspective view of a portion of a work vehicle according to an embodiment;

FIG. 2 is a side view of the work vehicle of FIG. 1; and

FIG. 3 is a view from the perspective of an operator of the work vehicle of FIG. 1.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Further embodiments of the invention may include any combination of features from one or more dependent claims, and such features may be incorporated, collectively or separately, into any independent claim.

### DETAILED DESCRIPTION OF THE DRAWINGS

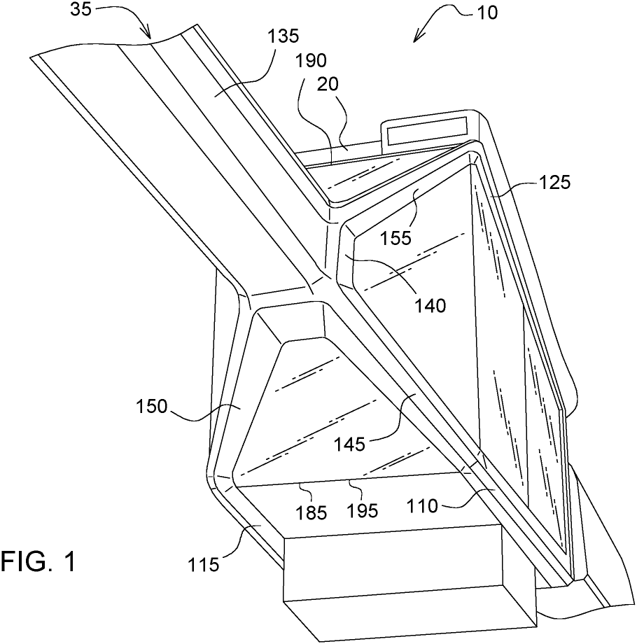

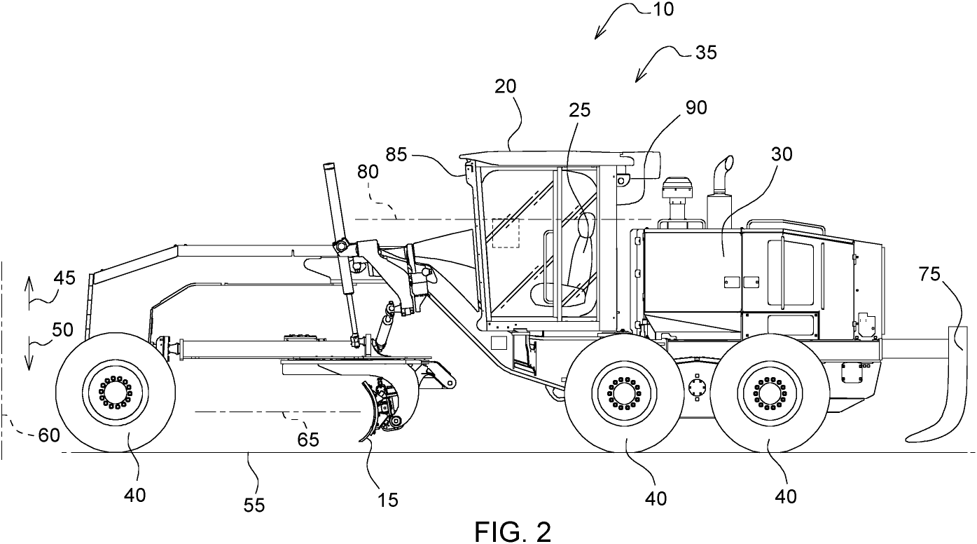

FIGS. 1-3 illustrate a work vehicle 10 comprising an implement 15, a cab or operator station 20 comprising a seat 25, and an engine 30. Referring to FIG. 1, the illustrated work vehicle 10 is a motor grader 35. The work vehicle 10 may be controlled by an operator located in the cab 20 or by an operator located remote from the work vehicle 10 having a camera view from inside the cab 20. The operator may command the work vehicle 10 to move forward, move backward, and turn. With reference to FIG. 2, those commands are sent to hydraulic pumps, driven by the engine 30, which direct pressurized hydraulic fluid to hydraulic motors that turn wheels 40. The engine 30 may be a diesel engine. Alternatively, the wheels 40 may be turned by electric motors.

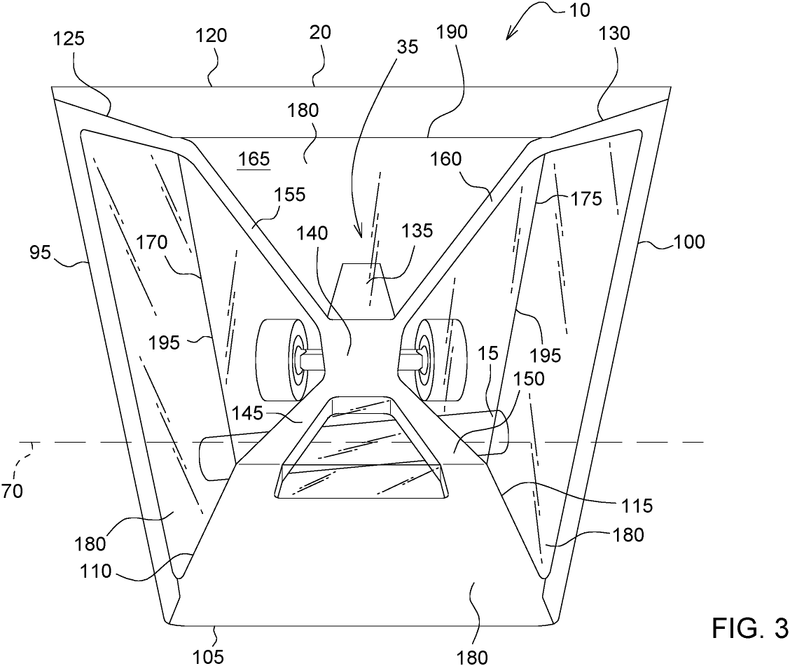

In addition, the operator may command the implement 15 to move. The implement 15 may be positioned at a front of the work vehicle 10 and may be attached to the work vehicle 10 in a number of different manners. In this embodiment, the implement 15 is attached to the work vehicle 10 through a linkage which includes a series of pinned joints, structural members, and hydraulic cylinders. This configuration allows the implement 15 to be moved up 45 and down 50 relative to a surface 55 or ground, rotate around a vertical axis 60 (i.e., an axis normal to the ground), rotate around an implement longitudinal axis 65 (e.g., a fore-aft axis of the work vehicle 10), and rotate around a lateral axis 70 (FIG. 3) of the work vehicle 10 (i.e., a left-right axis of the work vehicle 10). These degrees of freedom permit the implement 15 to engage the ground at multiple depths and cutting angles. Alternative embodiments may involve implements 15 with greater degrees of freedom and those with fewer degrees of freedom.

The operator may command movement of the implement 15 from the cab 20, which may be coupled to the work vehicle 10 and positioned behind the implement 15 or located remotely. Those commands are sent, including mechanically, hydraulically, and/or electrically, to a hydraulic control valve. The hydraulic control valve receives pressurized hydraulic fluid from a hydraulic pump, and selectively sends such pressurized hydraulic fluid to a system of hydraulic cylinders based on the operator’s commands. The hydraulic cylinders, which in this case are double-acting, are extended or retracted by the pressurized fluid and thereby actuate the implement 15. Alternatively, electronic actuators may be used.

With continued reference to FIG. 2, the illustrated work vehicle 10 is the motor grader 35 with a ripper 75 for operating on the surface 55 for spreading and leveling dirt, gravel, or other materials. The cab 20 of the motor grader 35 has a longintudinal axis 80 extending between a front 85 of the cab 20 and a rear 90 of the cab 20 opposite to the front 85 of the cab 20. Referring to FIG. 3, an operator faces the front 85 of the cab 20. The cab 20 comprises a left side portion 95 and a right side portion 100, opposite of the left side portion 95. A floor 105 is coupled to the left side portion 95 forming a left floor edge 110 and coupled to the right side portion 100 forming a right floor edge 115. A roof 120 is coupled to the left side portion 95 forming a left roof edge 125 and coupled to the right side portion 100 forming a right roof edge 130. The roof 120 is positioned above the floor 105. A frame 135 is provided for supporting the front 85 of the cab 20. The frame 135 may be a metal casting. The frame 135 is positioned above the floor 105 in a central portion 140 of the front of the cab 20. A first support 145 is coupled to the frame 135 and extends from the central portion 140 towards the left floor edge 110. A second support 150 is coupled to the frame 135 and extends from the central portion 140 towards the right floor edge 115. A third support 155 is coupled to the frame 135 and extends from the central portion 140 towards the left roof edge 125. A fourth support 160 is coupled to the frame 135 and extends from the central portion 140 towards the right roof edge 130. Alternatively, more or less supports (145,150,155,160) may be used.

The seat 25 may be coupled to at least one of the left side portion 95, the right side portion 100, the floor 105, and the roof 120 via at least one linkage. The seat 25 may be positioned to provide the operator a view of the surface 55 below the frame 135 at the front 85 of the cab 20 and/or a view of the surface 55 between the first support 145 and the second support 150.

A front portion 165 is coupled to the left side portion 95 forming a left front edge 170 and coupled to the right side portion 100 forming a right front edge 175. The front portion 165, the left side portion 95, the right side portion 100, and floor 105 may comprise a transparent portion 180 that may be glass or another see-through material. With reference to FIGS. 1 and 3, the front portion 165 is coupled to the floor 105 forming a front floor edge 185 and coupled to the roof 120 forming a front roof edge 190. The left front edge 170, the right front edge 175, and the front floor edge may comprise a seam 195 where multiple pieces of glass or other see-through material meet with no additional framing structure. The seam 195 may form a right angle, may be rounded, or may be more or less than ninety degrees. The seam 195 may include an adhesive such as glue with no metal framing structure. Advantageously, less framing structure and the seam 195 provide enhanced visibility.

The first support 145 and the third support 155 cover only a portion of the left front edge 170. The second support 150 and the fourth support 160 cover only a portion of the right front edge 175. The first support 145 and the second support 150 cover only a portion of the front floor edge 185. The remaining portions of the left front edge 170, the right front edge 175, and the front floor edge 185 may include the seam 195. Less framing structure and the seam 195 provide enhanced visibility.

What is claimed is:

1. A cab for a work vehicle that operates on a surface, the cab having a longintudinal axis extending between a front of the cab and a rear of the cab opposite to the front of the cab, an operator facing the front of the cab, the cab comprising:
a left side portion;
a right side portion, opposite of the left side portion;
a floor coupled to the left side portion forming a left floor edge and coupled to the right side portion forming a right floor edge;
a roof coupled to the left side portion forming a left roof edge and coupled to the right side portion forming a right roof edge, the roof positioned above the floor; and
a frame supporting the front of the cab, the frame positioned above the floor in a central portion of the front of the cab;
a first support coupled to the frame and extending from the central portion towards the left floor edge;
a second support coupled to the frame and extending from the central portion towards the right floor edge;
a third support coupled to the frame and extending from the central portion towards the left roof edge; and
a fourth support coupled to the frame and extending from the central portion towards the right roof edge.

2. The cab of claim 1, further comprising a seat coupled to at least one of the left side portion, the right side portion, the floor, and the roof, the seat positioned to provide the operator a view of the surface below the frame at the front of the cab.

3. The cab of claim 1, further comprising a seat coupled to at least one of the left side portion, the right side portion, the floor, and the roof, the seat positioned to provide the operator a view of the surface between the first support and the second support.

4. The cab of claim 1, further comprising a front portion coupled to the left side portion forming a left front edge and coupled to the right side portion forming a right front edge.

5. The cab of claim 4, wherein the front portion, the left side portion, the right side portion, and floor comprise a transparent portion.

6. The cab of claim 4, wherein the first support and the third support cover only a portion of the left front edge.

7. The cab of claim 4, wherein the second support and the fourth support cover only a portion of the right front edge.

8. The cab of claim 1, further comprising a front portion coupled to the floor forming a front floor edge and coupled to the roof forming a front roof edge.

9. The cab of claim 8, wherein the first support and the second support cover only a portion of the front floor edge.

10. A work vehicle that operates on a surface comprising:
an implement; and
a cab positioned behind the implement, the cab having a longintudinal axis extending between a front of the cab and a rear of the cab opposite to the front of the cab, an operator facing the front of the cab, the cab comprising:
a left side portion;
a right side portion, opposite of the left side portion;
a floor coupled to the left side portion forming a left floor edge and coupled to the right side portion forming a right floor edge;
a roof coupled to the left side portion forming a left roof edge and coupled to the right side portion forming a right roof edge, the roof positioned above the floor; and
a frame supporting the front of the cab, the frame positioned above the floor in a central portion of the front of the cab;
a first support coupled to the frame and extending from the central portion towards the left floor edge;
a second support coupled to the frame and extending from the central portion towards the right floor edge;
a third support coupled to the frame and extending from the central portion towards the left roof edge; and
a fourth support coupled to the frame and extending from the central portion towards the right roof edge.

11. The work vehicle of claim 10, further comprising a seat coupled to at least one of the left side portion, the right side portion, the floor, and the roof, the seat positioned to provide the operator a view of the surface below the frame at the front of the cab.

12. The work vehicle of claim 10, further comprising a seat coupled to at least one of the left side portion, the right side portion, the floor, and the roof, the seat positioned to provide the operator a view of the surface between the first support and the second support.

13. The work vehicle of claim 10, further comprising a front portion coupled to the left side portion forming a left front edge and coupled to the right side portion forming a right front edge.

14. The work vehicle of claim 13, wherein the front portion, the left side portion, the right side portion, and floor comprise a transparent portion.

15. The work vehicle of claim 13, wherein the first support and the third support cover only a portion of the left front edge.

16. The work vehicle of claim 13, wherein the second support and the fourth support cover only a portion of the right front edge.

17. The work vehicle of claim 10, further comprising a front portion coupled to the floor forming a front floor edge and coupled to the roof forming a front roof edge.

18. The work vehicle of claim 17, wherein the first support and the second support cover only a portion of the front floor edge.

19. The work vehicle of claim 10, further comprising a seat coupled to at least one of the left side portion, the right side portion, the floor, and the roof, the seat positioned to provide the operator a view of the implement between the first support and the second support.

20. A work vehicle that operates on a surface, the work vehicle comprising:
an implement; and
a cab positioned behind the implement, the cab having a longintudinal axis extending between a front of the cab and a rear of the cab opposite to the front of the cab, an operator facing the front of the cab, the cab comprising:
a left side portion;
a right side portion, opposite of the left side portion;
a floor coupled to the left side portion forming a left floor edge and coupled to the right side portion forming a right floor edge;
a roof coupled to the left side portion forming a left roof edge and coupled to the right side portion forming a right roof edge, the roof positioned above the floor; and
a frame supporting the front of the cab, the frame positioned above the floor in a central portion of the front of the cab;
a first support coupled to the frame and extending from the central portion towards the left floor edge;
a second support coupled to the frame and extending from the central portion towards the right floor edge;
a third support coupled to the frame and extending from the central portion towards the left roof edge; and
a fourth support coupled to the frame and extending from the central portion towards the right roof edge; and
a seat coupled to at least one of the left side portion, the right side portion, the floor, and the roof, the seat positioned to provide the operator a view of the implement below the frame at the front of the cab.
